(19) United States
(12) Patent Application Publication
(10) Pub. No.: US 2020/0285177 A1
(43) Pub. Date: Sep. 10, 2020

(54) IMAGE FORMING DEVICE

(71) Applicant: Konica Minolta, Inc., Tokyo (JP)

(72) Inventor: Tatsutoshi YAMADA, Toyokawa-shi (JP)

(21) Appl. No.: 16/812,290

(22) Filed: Mar. 7, 2020

(30) Foreign Application Priority Data
Mar. 7, 2019 (JP) 2019-041323

(51) Int. Cl. G03G 15/20

(52) U.S. Cl. CPC G03G 15/205; G03G 15/2053

(57) ABSTRACT

In an image forming device, a sheet type detector that detects a sheet type before the sheet reaches a fixing member; a temperature detector that detects a temperature of the fixing member; and a CPU that controls a heater based on the temperature detected to (a) after receiving an image formation start instruction and before a start of detection of the sheet type by the sheet type detector, start an increase in temperature of the fixing member towards a first target temperature higher than the temperature of the fixing member when image formation start instruction is received, and (b) after completion of the detection of the sheet type and before the sheet reaches the fixing member, adjust the temperature of the fixing member to a second target temperature depending on the sheet type detected.

### CROSS REFERENCE TO RELATED APPLICATIONS

The present invention claims priority under 35 U.S.C. § 119 to Japanese Patent Application No. 2019-41323 filed Mar. 7, 2019, the entire contents of which is hereby incorporated herein by reference.

### BACKGROUND

### (1) Technological Field

The present disclosure relates to image forming devices that form an unfixed image such as a toner image on a sheet and thermally fix the formed image via a fixing member, and in particular to an improvement in technology for detecting sheet type and adjusting temperature of fixing members to a temperature appropriate for the sheet type detected.

### (2) Description of the Related Art

An image forming device such as a printer forms an unfixed image such as a toner image on a sheet, and heat fixes the formed image using a fixing member heated by a heater.

As a control for such an image forming device, JP 2017-138406 describes that when a type of sheet stored in a sheet feed cassette has not been input, a media sensor detects the type of sheet while the sheet is being conveyed to a resist roller, the sheet is temporarily stopped on reaching the resist roller while heating of a fixing member to a target temperature corresponding to the detected sheet type is started, and when the fixing member reaches the target temperature, conveyance of the temporarily stopped sheet is resumed.

Through use of this control, the temperature of the fixing member when heat fixing can be set to a different target temperature depending on the sheet type, such as plain paper, thick paper, thin paper, or the like, which can improve fixing over a structure in which temperature of the fixing member is uniform regardless of sheet type.

### SUMMARY

However, according to the control described in JP 2017-138406, raising of temperature of the fixing member starts after detection of sheet type by the media sensor is complete, and therefore a time from sheet feed start to the fixing member reaching the target temperature is increased.

Heat fixing cannot be performed unless the fixing member has reached the target temperature, and therefore the longer it takes for the fixing member to reach the target temperature, the longer it takes from one sheet being fed to being discharged, known as the first print output time (FPOT), and print productivity decreases accordingly.

An object of the present disclosure is to provide an image forming device that adjusts temperature of a fixing member to a target temperature suitable for a detected sheet type, while also shortening FPOT.

To achieve at least the abovementioned object, according to an aspect of the present disclosure, an image forming device reflecting one aspect of the present disclosure is an image forming device that, when an image forming start instruction is received, feeds a sheet from a sheet storage, forms an image on the sheet, conveys the sheet to a fixing member heated by a heater, and thermally fixes the image on the sheet by using the fixing member, the image forming device including: a sheet type detector that detects a type of the sheet before the sheet reaches the fixing member; a temperature detector that detects a temperature of the fixing member; and a central processing unit (CPU). The CPU controls the heater based on a result of detection by the temperature detector to (a) after the reception of the image formation start instruction and before a start of detection of the type of the sheet by the sheet type detector, start an increase in temperature of the fixing member towards a first target temperature that is higher than the temperature of the fixing member when the image formation start instruction is received, and (b) after completion of the detection of the type of the sheet and before the sheet reaches the fixing member, adjust the temperature of the fixing member to a second target temperature that depends on the type of the sheet detected.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the invention. In the drawings:

FIG. 1 is a diagram illustrating an overall structure of a printer.

FIG. 2 is a block diagram illustrating structure of a main controller.

FIG. 3 is a diagram illustrating an example display of a sheet type automatic detection necessity screen.

FIG. 4 is a diagram illustrating example content of a table showing cumulative sheet usage history information.

FIG. 5 is a diagram illustrating example content of a target temperature determination table.

FIG. 6 is a diagram illustrating example content of target temperature information.

FIG. 7 is a diagram illustrating example content of sheet type information.

FIG. 8 is a flowchart illustrating sheet feed control.

FIG. 9 is a flowchart illustrating fixing roller temperature control.

FIG. 10 is a flowchart illustrating a first target temperature determination subroutine.

FIG. 11A is a diagram illustrating a temperature control timing chart of an embodiment, and FIG. 11B is a diagram illustrating a temperature control timing chart of a reference example.

### DETAILED DESCRIPTION

The following describes an embodiment of an image forming device pertaining to the present disclosure using a tandem color printer (also referred to as “printer”) as an example.

(1) Overall Structure

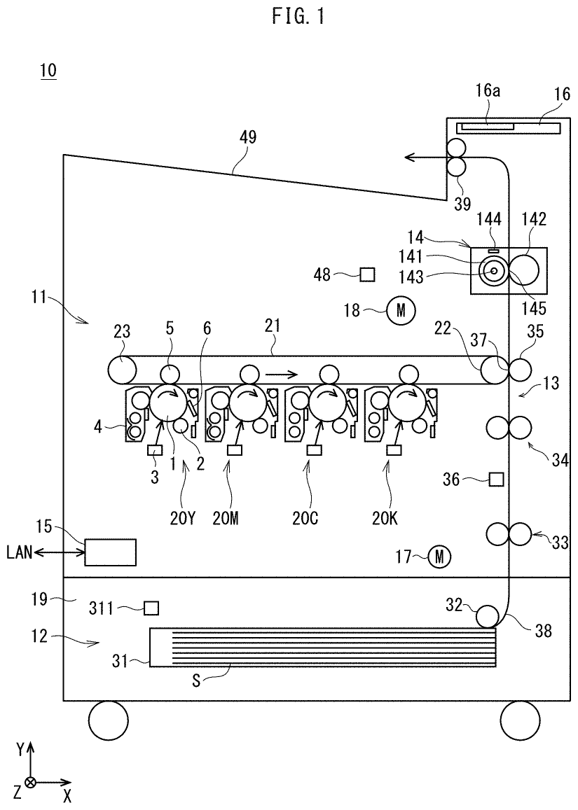

FIG. 1 is a diagram illustrating an overall structure of a printer 10. In FIG. 1, where the printer 10 is viewed from the front, the left-right direction is an X-axis direction, the up-down direction is a Y-axis direction, and the direction orthogonal to both the X-axis and the Y-axis is a Z-axis direction. The Z-axis direction corresponds to a device front-back direction.

As illustrated in FIG. 1, the printer 10 includes an image former 11, a sheet feeder 12, a conveyer 13, a fixing unit 14, an overall controller 15, and an operation unit 16, is connected to a network such as a local area network (LAN), and executes printing based on a job execution instruction from an external terminal (not illustrated).

The image former 11 includes imaging units 20Y, 20M, 20C, 20K corresponding to yellow (Y), magenta (M), cyan (C), black (K) colors, an intermediate transfer belt 21, and the like.

The imaging units 20Y, 20M, 20C, 20K are arranged in a straight line at defined intervals along the intermediate transfer belt 21. The imaging unit 20Y includes a photosensitive drum 1, and arranged around the photosensitive drum 1 a charger 2, an exposure unit 3, a developer unit 4, a primary roller 5 that together with the photosensitive drum 1 sandwiches the intermediate transfer belt 21, a cleaner 6 that cleans a surface of the photosensitive drum 1, and the like. The imaging unit 20Y forms a yellow toner image on the photosensitive drum 1. The imaging units 20M, 20C, 20K have structures essentially the same as that of the imaging unit 20Y, but form toner images of their corresponding colors. In FIG. 1 there are no reference symbols for components of the imaging units 20M, 20C, 20K.

The intermediate transfer belt 21 is an endless belt, is kept taught around a drive roller 22 and a driven roller 23, and runs in a direction indicated by an arrow in FIG. 1.

The sheet feeder 12 includes a sheet cassette 31, a feeding roller 32, and a conveyance roller pair 33. The conveyer 13 includes a resist roller pair 34, a secondary transfer roller 35 that presses against the drive roller 22 through the intermediate transfer belt 21 at a secondary transfer position 37, and a discharge roller pair 39.

The sheet cassette 31 is a sheet storage that can store multiple sheets S, for example a maximum of 500 sheets. The sheet cassette 31 can be pulled out from a storage position in a main body 19 to a replenishment position to the front of the device by using a member such as a rail (not illustrated).

When the sheets S in the sheet cassette 31 run out because all the sheets S stored in the sheet cassette 31 have been fed out, a user can pull out the sheet cassette 31 from the storage position to the replenishment position, and then replenish the sheet cassette 31 with new sheets S. After replenishing the sheets S, the user can push the sheet cassette 31 towards the back of the device to return the sheet cassette 31 to the storage position. When the sheet cassette 31 is in the storage position, the sheets S can be fed out.

Pulling out the sheet cassette 31 from the storage position to the replenishment position is referred to as an opening operation of the sheet cassette 31, and returning the sheet cassette 31 from the replenishment position to the storage position is referred to as a closing operation of the sheet cassette 31. An opening/closing operation of the sheet cassette 31 from the opening operation to the closing operation is performed each time the sheets S in the sheet cassette 31 run out, and this opening/closing operation is detected by a cassette opening/closing sensor 311. A detection result indicating execution of an opening/closing operation of the sheet cassette 31 from the cassette opening/closing sensor 311 is transmitted to the overall controller 15.

The feeding roller 32 feeds sheets S set in the sheet cassette 31 to a conveyance path 38. the conveyance roller pair 33 conveys a sheet S fed out by the feeding roller 32 towards the resist roller pair 34.

The resist roller pair 34 takes a timing to send the sheet S conveyed from the conveyance roller pair 33 to the secondary transfer position 37, and also has a function of correcting skew of the sheet S. More specifically, the resist roller pair 34 is stopped, and a leading end in the conveyance direction of the sheet S conveyed by the conveyance roller pair 33 is brought into contact with a nip formed between the resist roller pair 34. Thus, the leading end of the sheet S bends to form an arch. This forming of the arch corrects skew of the sheet S. Then when it is time (described later) to send the sheet S to the secondary transfer position 37, the resist roller pair 34 starts rotating (resumes conveyance of the sheet S), conveying the sheet S to the secondary transfer position 37.

The feeding roller 32 and the conveyance roller pair 33 are rotated by rotational drive of a sheet feed motor 17. Further, the resist roller pair 34, the secondary transfer roller 35, and the discharge roller pair 39 are rotated by rotational drive of a drive motor 18. The resist roller pair 34 receives rotational drive of the drive motor 18 via an electromagnetic clutch (not illustrated). By switching on and off of the electromagnetic clutch, the resist roller pair 34 can switch between stopping and rotating independently.

The fixing unit 14 presses a fixing roller 141 and a pressure roller 142 together to form a fixing nip 145, and heats the fixing roller 142 via a heater 143 to maintain a temperature required for fixing (fixing temperature: second target temperature, described later). Temperature of the fixing roller 141 is detected by a fixing member temperature sensor 144. This detection result is transmitted to the overall controller 15.

The overall controller 15 converts an image signal from an external terminal device to Y, M, C, K digital signals, and generates drive signals for driving light sources of the exposure units 3 of the imaging units 20Y, 20M, 20C, 20K. According to the generated drive signals, for each of the imaging units 20Y, 20M, 20C, 20K, the light source of the exposure unit 3 is driven to emit a light beam, exposing and scanning the photosensitive drum 1 (image writing).

For each of the imaging units 20Y, 20M, 20C, 20K, the photosensitive drum 1 is uniformly charged by the charger 2 before the exposure scanning, and exposure to the light beam forms an electrostatic latent image of the image to be formed on the photosensitive drum 1, after which the electrostatic latent image is developed with toner by the developer unit 4.

Each color of toner image is transferred onto the intermediate transfer belt 21 due to an action of electrostatic force generated by an electric field between the primary transfer roller 5 and the photosensitive drum 1. At this time, image forming operations for each color are executed at different timings so that the toner images are transferred superimposed on the same position on the intermediate transfer belt 21. The color toner images superimposed on the intermediate transfer belt 21 are moved towards the secondary transfer position 37 as the intermediate transfer belt 21 moves. In parallel with this image forming operation, a sheet S is conveyed from the resist roller pair 34 to the secondary transfer position 37.

Rotation start timing of the resist roller pair 34 (sheet S conveyance resumption timing) is controlled so that timing of arrival at the secondary transfer position 37 of the toner image on the intermediate transfer belt 21 matches timing of arrival at the secondary transfer position 37 of the leading end of the sheet S.

More specifically, circumferential speed of the photosensitive drum 1 and circumferential speed of the intermediate transfer belt 21 are the same, and a distance a toner image formed on the photosensitive drum 1 of the imaging unit 20Y, which is farthest upstream, travels on the intermediate transfer belt 21 until reaching the secondary transfer position 37 is known in advance. Thus, if the circumferential speed of the intermediate transfer belt 21 is known, a time Qa required for a toner image on the intermediate transfer belt 21 to reach the secondary transfer position 37 from the start of writing to the photosensitive drum 1 of the imaging unit 20Y is calculable, and an actual time when the toner image on the intermediate transfer belt 21 reaches the secondary transfer position 37 can be estimated.

On the other hand, a distance L on the conveyance path from the resist roller pair 34 to the secondary transfer position 37 is determined in advance, and conveyance speed V of a sheet S by the resist roller pair 34 is the same as the circumferential speed of the intermediate transfer belt 21. Thus, when a time Qb is the distance L divided by the speed V, as long as rotation of the resist roller pair 34 is started at a time Qc obtained by subtracting the time Qb from the above estimated time, a timing at which the toner image on the intermediate transfer belt 21 reaches the secondary transfer position 37 can be matched to a timing at which the leading end of the sheet S reaches the secondary transfer position 37. The time Qc is also referred to as a timing at which a sheet S is sent to the secondary transfer position 37.

For example, when Qa−Qb=α (≥0), a time when a defined time a has elapsed from the start of image formation is the time Qc, or in other words a time at which conveyance of the sheet S resumes. In a device configuration in which a is negative, the timing of the start of image formation and the resumption of conveyance of the sheet S have a reversed relationship.

When the leading end of the sheet S reaches the secondary transfer position 37, the sheet S is gripped and conveyed by the intermediate transfer belt 21 and the secondary transfer roller 35, while under the action of an electrostatic field generated by the secondary transfer roller 35 in order to transfer at once all the toner images on the intermediate transfer belt 21 to the sheet S.

The sheet S that has passed the secondary transfer position 37 is conveyed to the fixing unit 14. In the fixing unit 14, the temperature of the fixing roller 141 is controlled to reach a fixing temperature suitable for the type of the sheet S, based on a detection result of the fixing member temperature sensor 144, prior to the leading end of the sheet S reaching the fixing roller 141. The temperature control is described later.

The toner image is fixed to the sheet S by heat and pressure when passing through the fixing nip 145 formed by the fixing roller 141 and the pressure roller 142, after which the sheet S is discharged to the outside of the device by the discharge roller pair 39 to be stored on a storage tray 49.

The fixing roller 141 and the pressure roller 142 are rotated by the rotational drive of the drive motor 18, as other rotating bodies such as the photosensitive drums 1 of the imaging units 20Y, 20M, 20C, 20K and the intermediate transfer belt 21 are rotated by the rotational drive of the drive motor 18.

The above describes an example of a color mode color printing using four colors Y, M, C, K, but the printer 10 can also execute monochrome mode monochrome printing using only one color, such as K.

The monochrome K mode is difference from the color mode in that the imaging units 20Y, 20M, 20C for Y, M, C colors are not driven, and only the imaging unit 20K for K color is driven to transfer a K color toner image onto the intermediate transfer belt 21 to then be transferred from the intermediate transfer belt 21 to the sheet S at the secondary transfer position 37. Further, in the monochrome K mode, the time when the toner image on the intermediate transfer belt 21 reaches the secondary transfer position 37 can be estimated by replacing the imaging unit 20Y with the imaging unit 20K.

Whether the color mode or the monochrome mode is executed depends on user instruction, but a control may be implemented to automatically determine whether image data supplied for printing is color data or monochrome data, and in the case of color data switch the print mode to the color mode, and in the case of monochrome data switch the print mode to the monochrome mode.

A media sensor 36 for detecting type of the sheet S while the sheet S is being conveyed towards the resist roller pair 34 on the conveyance path 38 is disposed in the vicinity of the conveyance path 38, downstream in the sheet conveyance direction from the conveyance roller pair 33 and upstream in the sheet conveyance direction from the resist roller pair 34. The type of the sheet S detected is used in temperature control of the fixing roller 141.

As the media sensor 36, a reflection type optical sensor or the like is used, the reflection type optical sensor irradiating the sheet S with light emitted from a light emitter, receiving light reflected from the sheet S with a light receiver, and outputting a single such as a voltage according to an amount of reflected light. Depending on the type of the sheet S, for example plain paper, thick paper, thin paper, etc., the amount of reflected light differs and therefore the output voltage differs.

By storing information on output voltage for each sheet type in advance, the type of the sheet S being conveyed can be determined from the output voltage level determined by the media sensor 36. The media sensor 36 is not limited to being an optical sensor as long as it is a sheet type detector that can detect the type of the sheet S. For example, an ultrasound sensor can be used. Output signals of the media sensor 36 are transmitted to the overall controller 15.

A temperature/humidity sensor 48 is disposed in the in the main body 19 at a position in the vicinity of the fixing unit 14. The temperature/humidity sensor 48 detects temperature and humidity in a space around the fixing unit 14. This detection result is transmitted to the overall controller 15.

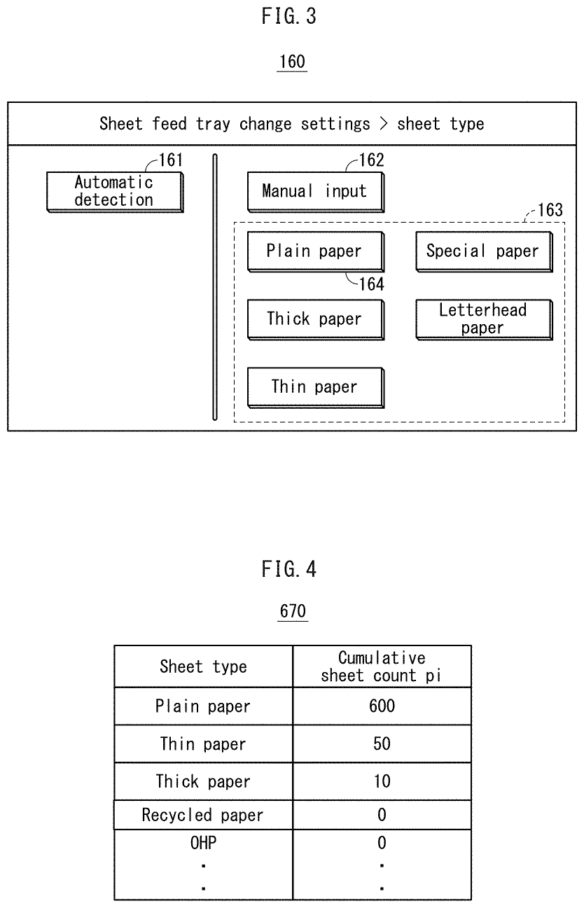

The operation unit 16 is on a front side of the device in a position where it can be easily operated by a user. The operation unit 16 has keys and the like for accepting input of print conditions such as the number of prints, brightness, etc. Further, the operation unit 16 has a display 16a including a touch panel for displaying screens such as a screen type selection screen 160 (FIG. 3, described later) for accepting input of a sheet type manual input mode in which a user manually inputs the type of the sheet S stored in the sheet cassette 31 or a sheet type automatic detection mode in which the media sensor 36 automatically detects sheet type without manual user input. Input information received by the operation unit 16 is transmitted to the overall controller 15.

(2) Structure of Overall Controller

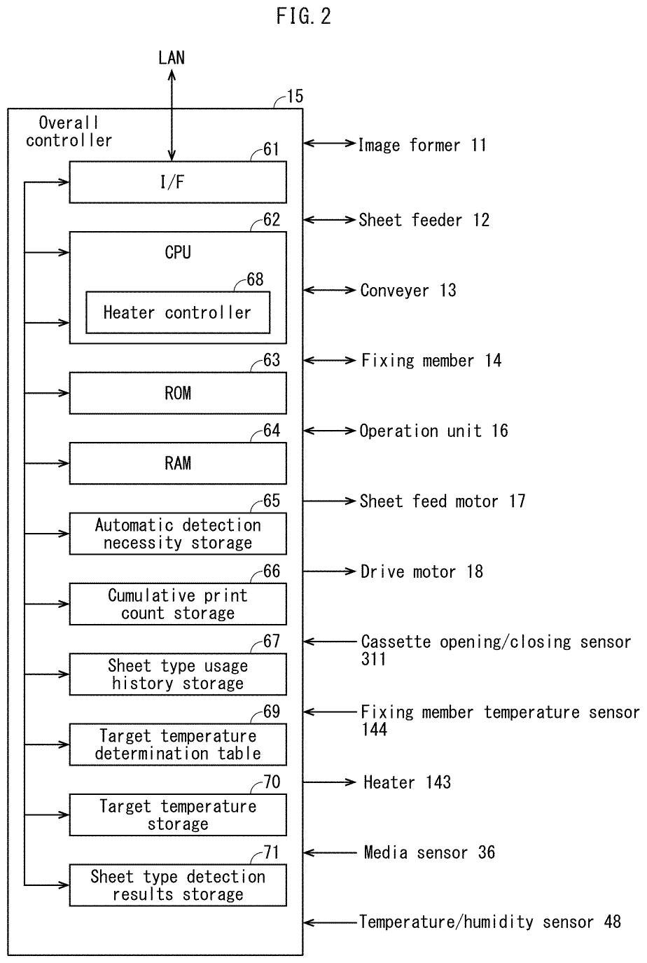

FIG. 2 is a block diagram illustrating structure of the overall controller 15.

As illustrated in FIG. 2, the overall controller 15 includes a communication interface (I/F) 61, a central processing unit (CPU) 62, a read-only memory (ROM) 63, a random access memory (RAM) 64, an automatic detection necessity storage 65, a cumulative print count storage 66, a sheet type usage history storage 67, a target temperature determination table 69, a target temperature storage 70, and a sheet type detection result storage 71, all capable of communicating with each other. The CPU 62 includes a heater controller 68.

The communication I/F 61 is an interface for connecting to a network such as a local area network (LAN), such as a LAN card or LAN board, and receives print job data from an external source (not illustrated) via the network.

The CPU 62 reads a required program from the ROM 63 based on information input from the operation unit 16 by a user, to comprehensively control the image former 11, the sheet feeder 12, the conveyor 13, and the fixing unit 14 to smoothly execute a print job.

Further, the CPU 62 monitors the temperature of the fixing roller 141 as needed from the detection results of the fixing member temperature sensor 144. When the sheet type automatic detection mode is selected, and a sheet S is temporarily stopped by the resist roller pair 34 while executing a print job with respect to the sheet S, the CPU 62 causes an imaging operation by the image former 11 to start when a temperature of the fixing roller 141 reaches a defined temperature, for example a temperature 5 degrees Celsius lower than a target fixing temperature (second target temperature).

The defined temperature that triggers the start of the imaging operation is determined in advance by experiments or the like as a temperature that ensures sufficient time for the fixing roller 141 to increase in temperature to and maintain at the target fixing temperature by the time the sheet S reaches the fixing roller 141 via the secondary transfer position 37 due to conveyance by the resist roller pair 34.

Accordingly, after the start of the imaging operation, the temperature of the fixing roller 141 is adjusted to the target temperature when the sheet S conveyed by the resist roller pair 34 and with a toner image transferred thereon at the secondary transfer position 37 arrives at the fixing roller 141, and the toner image on the sheet S can be heat-fixed at the appropriate temperature.

The RAM 64 provides a work area for the CPU 62.

The automatic detection necessity storage 65 is a non-volatile storage that stores automatic detection necessity information indicating a result of selection of the sheet type automatic detection mode and the sheet type manual input mode by a user, where selection of mode is performed via a sheet type automatic detection necessity storage screen 160 (also referred to as “screen 160”) displayed on the display 16a of the operation unit 16.

FIG. 3 is a diagram illustrating an example of the screen 160.

As illustrated in FIG. 3, the screen 160 displays an automatic detection button 161 and a manual input button 162. Below the manual input button 162 is displayed a sheet type button group 163 in which display buttons indicating different sheet types are arranged. In FIG. 3, the sheet type button group 163 shows five buttons indicating five types including plain paper, thick paper, and thin paper, but sheet types are not limited to these examples, and one or more buttons for any sheet types that the printer 10 can print onto can be displayed.

When a user wishes to omit inputting the type of the sheets S stored in the sheet cassette 31, the user can touch the automatic detection button 161. When the automatic detection button 161 is touched, information indicating that a user selected automatic detection is written to the automatic detection necessity storage 65 as automatic detection necessity information.

On the other hand, when a user inputs sheet type, after the manual input button 162 is touched, a display button indicating a sheet type to be recorded in the sheet type button group 163 can be touched. For example, when the type of sheet S currently stored in the sheet cassette 31 is plain paper, a user may touch a plain paper button 164.

After the manual input button 162 is touched, when a display button of the sheet type button group 163 is touched, information indicating that a user has selected manual input and the manually input sheet type is written to the automatic detection necessity storage 65 as automatic detection necessity information. Writing automatic detection necessity information to the automatic detection necessity storage 65 is performed by the CPU 62 overwriting previous information, and therefore written information is updated each time.

Returning to FIG. 2, the cumulative print count storage 66 is a non-volatile storage that stores cumulative print count information indicating a total cumulative print count (cumulative image formation count) of sheets S used for printing from the time the printer 10 was new to the present. The cumulative print count information is updated by the CPU 62 as follows.

That is, each time one sheet S is fed out from the sheet cassette 31 and conveyed on (passes through) the conveyance path 38, the current cumulative print count is read out from the cumulative print count storage 66, incremented by “1”, and overwritten as a new cumulative print count to the cumulative print count storage 66.

The sheet type usage history storage 67 is a non-volatile storage that stores sheet type usage history information indicating a total number of sheets S used in printing for each type of sheet S from the time the printer 10 was new to the present.

FIG. 4 is a diagram illustrating example content of a table 670 showing cumulative sheet usage history information.

As illustrated in FIG. 4, a cumulative count pi indicating past usage history is written in association with each sheet type. The usage history information is updated by the CPU 62 as follows. That is, every time one sheet S passes through the conveyance path 38, the type of sheet S is detected by the media sensor 36 when the sheet S passes the detection position of the media sensor 36. The current cumulative count pi corresponding to the detected sheet type is read from the table 670, incremented by “1”, and updated (overwritten) as a new cumulative count pi.

Returning to FIG. 2, the heater controller 68 (CPU) monitors the current temperature of the fixing roller 141 based on a detection result of the fixing member temperature sensor 144, and controls the temperature of the fixing roller 141 by a switching control, switching the heater 143 on and off.

More specifically, at a non-image-formation time when printing is not performed, the heater 143 is controlled so that temperature of the fixing roller 141 is maintained at a standby temperature during standby until the next print execution instruction (image formation start instruction) is received. By preliminary heating the fixing roller 141 during standby, it is possible to shorten the time required to raise the fixing roller 141 to the fixing temperature when the next print execution instruction is issued. However, if the standby temperature is set too high, a power saving effect is reduced, and therefore a suitable temperature is set in advance as the standby temperature, taking into consideration both power saving and time required for temperature increase. The printer 10 in a standby state is also referred to as a standby mode.

When a print execution instruction is received in the standby mode, a control is executed canceling the standby mode and raising the temperature of the fixing roller 141 from the standby temperature to the target temperature, maintaining the temperature of the fixing roller 141, or the like. For this control, the heater controller 68 also uses the sheet type, a detection result of the temperature/humidity sensor 48, and a detection result of the cassette opening/closing sensor 311. Further, when printing and a specific condition described later is satisfied, a control is executed to switch the target temperature of the fixing roller 141 to a second target temperature reached via the first target temperature from the standby temperature. The temperature control is described later.

When the printer 10 is executing a printing operation this is referred to a print mode, and when the printing operation is completed, the printing mode is changed to the standby mode. Every time a print execution instruction is received, mode switching occurs from the standby mode to the standby mode via the print mode.

The target temperature determination table 69 is a temperature table stored in a non-volatile storage used for determining the target temperature (standby temperature, first target temperature, second target temperature) of the fixing roller 141.

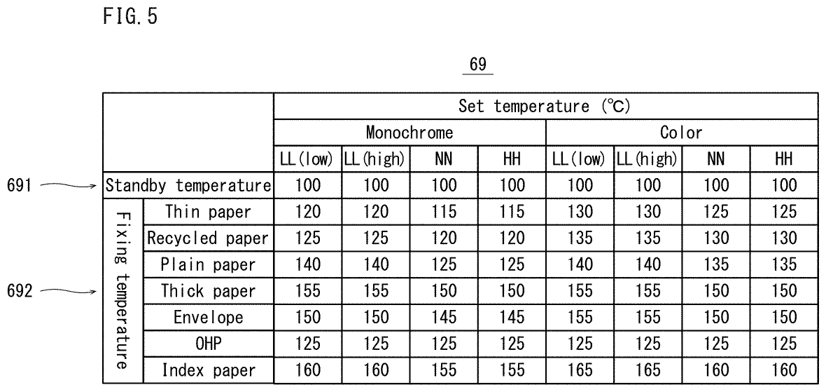

FIG. 5 is a diagram illustrating example content of the target temperature determination table 69.

As illustrated in FIG. 5, the target temperature determination table 69 includes a standby temperature column 691 and a fixing temperature column 692. The fixing temperature column 692 is divided into different sheet types, such as thin paper, recycled paper, plain paper, etc., and for each of the different sheet types, a fixing temperature that should be set for each combination of monochrome mode and color mode and environment, where environment is indicated by low temperature, low humidity (LL), normal temperature, normal humidity (NN), and high temperature, high humidity (HH).

Here, plain paper is assumed to have a grammage (g/m²) in a range from 60 to 119, thin paper in a range from 50 to 59, and thick paper 120 or more.

Further, LL (low) indicates 5° C., 10% relative humidity (RH), LL (high) indicates 10° C., 15% RH, NN indicates 20° C., 60% RH, and HH indicates 30° C., 85% RH, but these are of course just examples, and temperature and humidity are set according to device structure. The environment (temperature and humidity) is detected by the temperature/humidity sensor 48.

The standby temperature is a target temperature in the standby mode until the next print instruction is issued while printing is not being executed. In the example illustrated in FIG. 5, the standby temperature is uniformly set to the same temperature regardless of print mode (monochrome mode/color mode) and environment, specifically 100° C.

The fixing temperature is a temperature necessary for thermally fixing the toner image to the sheet S, and is specifically set according to the print mode and environment for each sheet type.

For example, the fixing temperature for plain paper is set to 125° C. in the monochrome mode under the NN environment but is set to 135° C. in the color mode under the NN environment. This is for the following reason. In the monochrome mode, only one color of toner image is transferred onto the sheet S, but in the color mode, two or more colors of toner image are superimposed on the sheet S and more heat is required than in the monochrome mode to fix the image, and therefore it is necessary to set the fixing temperature higher.

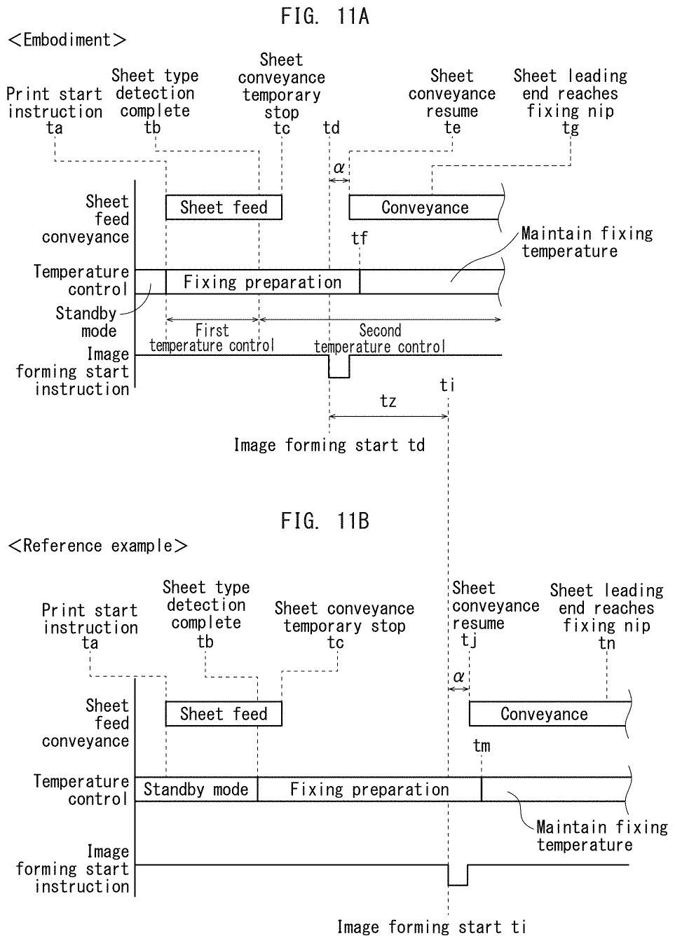

Of the three target temperatures of the fixing roller 141, the standby temperature is the temperature in the standby temperature column 691 of the target temperature determination table 69. The second target temperature is equal to the temperature in the fixing temperature column 692 of the target temperature determination table 69, i.e., the fixing temperature suitable for the sheet type, print mode, and environment for each of the sheets S. The first target temperature is determined to be one of the temperatures of the fixing temperature column 692 by first target temperature determination processing described later (see FIG. 10).

Returning to FIG. 2, the target temperature storage 70 is a nonvolatile storage that stores target temperature information indicating the first target temperature and the second target temperature, and the sheet type detection result storage 71 is a nonvolatile storage that stores sheet type information indicating a type of the sheet S detected by the media sensor 36.

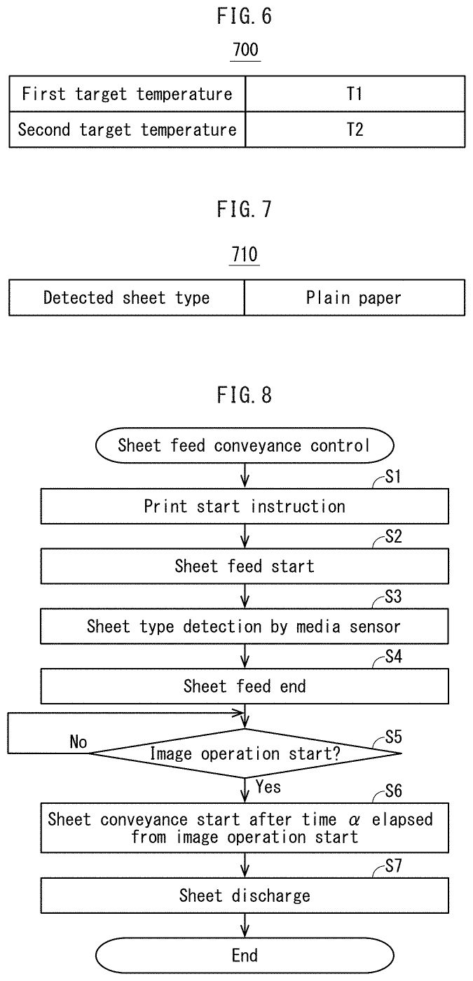

FIG. 6 is a diagram illustrating example content of target temperature information 700, in which the first target temperature and the second target temperature are written. Each time the first target temperature and the second target temperature are determined, the target temperature determined is overwritten and stored in the corresponding storage region in the target temperature storage 70.

FIG. 7 is a diagram illustrating example content of sheet type information 710 in which a detected sheet S type is written. A detection result of sheet type by the media sensor 36 is written in the sheet type detection result storage 71 only when the above specific condition is satisfied, but is overwritten and stored each time the writing occurs.

(3) Sheet Feed Control

FIG. 8 is a flowchart illustrating sheet feed control by the CPU 62.

As illustrated in FIG. 8, when a print execution start instruction (image formation start instruction) is received (step S1), feeding of once sheet S is started (step S2).

Sheet S feed start means that the sheet S is fed out from the sheet cassette 31 by the feeding roller 32. By starting sheet feeding, the sheet S fed out by the feeding roller 32 is conveyed towards the stopped resist roller pair 34 via the conveyance roller pair 33.

The type of the sheet S is detected while the leading end of the sheet S passes the detection position of the media sensor 36, after passing the conveyance roller pair 33 (step S3).

After the leading end of the sheet S passes the detection position of the media sensor 36 and reaches the stationary resist roller pair 34, feeding stops, or in other words the feeding roller 32 and the conveyance roller pair 33 are stopped, when a leading end portion of the sheet S forms an arch of a defined size (step S4).

After feeding stops, it is determined whether or not an imaging operation is started (step S5). An imaging operation is started when the temperature of the fixing roller 141 reaches a temperature lower than the fixing temperature by a defined amount, as described above.

When it is determined that an imaging operation is started (“Yes” in step S5), the resist roller pair 34 start to rotate after the define time a has elapsed from the start of imaging, resuming conveyance of the sheet S (step S6). Due to the resumption of conveyance of the sheet S, the sheet S is conveyed towards the discharge roller pair 39 via the secondary transfer position 37 and the fixing unit 14. When conveyance is resumed, the intermediate transfer belt 21, the secondary transfer roller 35, the fixing roller 141, the pressure roller 142, and the discharge roller pair 39 also rotate.

When the sheet S passes through the secondary transfer position 37, the toner image on the intermediate transfer belt 21 is transferred onto the sheet S, and when the sheet S passes through the fixing nip 145, the toner image on the sheet S is fixed by heat and pressure.

When the sheet S having passed through the fixing unit 14 reaches the discharge roller pair 39, the sheet S is discharged by the discharge roller pair 39 (step S7), and the control ends.

(4) Heater Control Processing

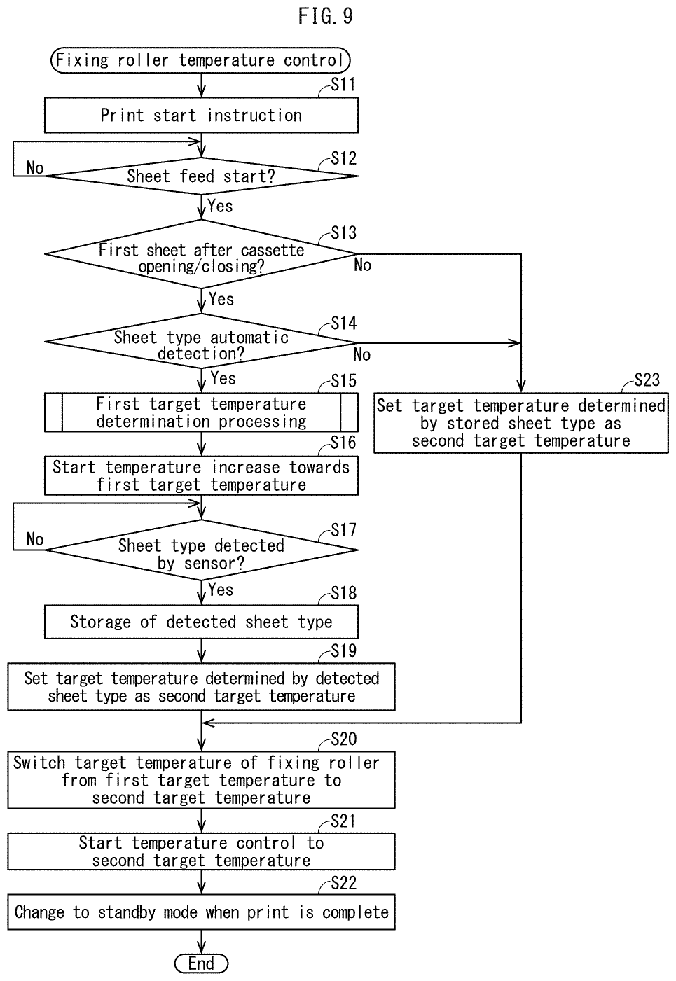

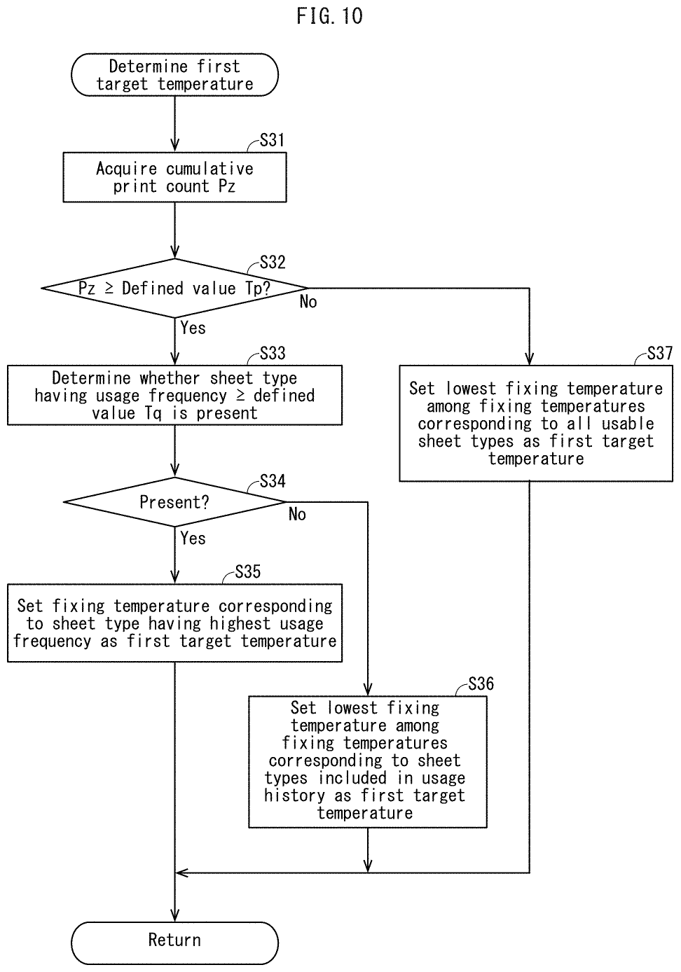

FIG. 9 is a flowchart illustrating temperature control of the fixing roller 141 by the heater controller 68.

As illustrated in FIG. 9, when there is a print execution start instruction (step S11), the standby mode is changed to the print mode, and it is determined whether or not the feeding of a sheet S is started (step S12). This feeding start corresponds to the feeding start processing described above (step S2).

Next it is determined whether or not the sheet feeding is the first sheet feeding operation after an opening/closing operation of the sheet cassette 31 (step S13). The sheet feeding operation is determined to be the first sheet feeding operation when it is the first sheet fed after the cassette opening/closing sensor 311 detects execution of an opening/closing operation of the sheet cassette 31.

If it is determined that this is the first sheet feeding operation after an opening/closing operation of the sheet cassette 31 (“Yes” in step S13), it is determined whether or not sheet type automatic detection is selected (step S14). This determination is made by referring to the automatic detection necessity information stored in the automatic detection necessity storage 65.

If it is determined that sheet type automatic detection is selected (“Yes” in step S14), the first target temperature determination processing is executed (step S15). Conditions for executing the first target temperature determination processing, i.e., “Yes” in step S13 and “Yes” in step S14, correspond to satisfying the specific condition referred to in the description above.

FIG. 10 is a flowchart illustrating a subroutine of the first target temperature determination processing.

As illustrated in FIG. 10, the cumulative print count Pz is acquired (step S31). The cumulative print count Pz is acquired by reading the cumulative print count information currently stored in the cumulative print count storage 66.

Next, whether or not the cumulative print count Pz is equal to or greater than a defined value Tp is determined (step S32). Here, the defined value Tp is a value determined in advance as a number of sheets suitable for determining a trend of which type of sheet a user uses frequently, and can be set to 1,000 sheets, for example. This is for the following reason.

When a user replenishes sheets in the sheet cassette 31, typically a ream containing a certain number of sheets S (for example, 500 sheets) is opened and set in the sheet cassette 31 as is. Based on this assumption, when trying to determine the defined value Tp using the number of times of replenishment of the sheets S and the cumulative print count Pz as an index value, the first replenishment, i.e., 500 sheets S printed, is considered too few sheets to determine a trend of sheet type use by a user.

On the other hand, by the third replenishment, that is 1,500 sheets S printed, it is considered that a trend of sheet type use by a user is sufficiently revealed. Assuming that the first replenishment is too few, and the third replenishment too many, the second replenishment at 1,000 sheets can be considered to be the defined value Tp suitable for determining a trend of sheet type use by a user from the cumulative print count Pz. Of course, the defined value Tp is not limited to being 1,000, and a different value can be used.

Assuming the defined value Tp is 1,000 sheets, the cumulative print count Pz should be 1,000 at the end of the opening/closing operation of the sheet cassette 31 due to the third sheet replenishment. At the start of feeding the first sheet S after the opening/closing operation of the sheet cassette 31, the condition that the cumulative print count Pz is equal to or greater than the defined value Tp is satisfied.

If it is determined that the cumulative print count Pz≥the defined value Tp (“Yes” in step S32), it is determined whether or not there is a sheet type with a usage frequency equal to or greater than a defined value Tq (step S33).

Here, usage frequency is expressed as a percentage (%) as a ratio for each different sheet type obtained by dividing the cumulative sheet count pi of the sheet type by the cumulative print count Pz.

The defined value Tq is determined in advance as a value set such that, based on a user's sheet type usage history, a sheet type used frequently at a rate equal to or greater than the defined value Tq (for example, 50%) can be regarded as the sheet type assumed to be currently set in the sheet cassette 31.

This determination is made by referring to the sheet type usage history written to the table 670 (FIG. 4) of the sheet type usage history storage 67, and for each sheet type, calculating a ratio of the cumulative sheet count pi to the cumulative print count Pz.

For example, if the current cumulative print count Pz is 1,000, and the defined value Tq is 50%, and the cumulative sheet count pi for plain paper is 600 as in the example of FIG. 4, the usage frequency is 60%, which is higher than the defined value Tq and therefore it is determined that plain paper is the sheet type.

On determining that a usage frequency is equal to or higher than the defined value Tq (“Yes” in step S34), a fixing temperature corresponding to the sheet type having the highest usage frequency is used to determine the first target temperature T1 (step S35), and processing returns to the fixing roller temperature control.

In the example illustrated in FIG. 4, the most frequently used sheet type is plain paper, and therefore, referring to the plain paper column in the fixing temperature column 692 of the target temperature determination table 69 illustrated in FIG. 5, the fixing temperature corresponding to the print mode for the current job and the current environment is determined as the first target temperature T1. As a specific example, if the print mode is the color mode and the current environment is NN, the first target temperature is determined as 135° C.

On determining that a usage frequency is lower than the defined value Tq (“No” in step S34), a lowest fixing temperature among fixing temperatures corresponding to sheet types included in the usage history is used to determine the first target temperature T1 (step S36), and processing returns to the fixing roller temperature control.

For example, if the defined value Tq is 70%, a negative determination is made based on the example in FIG. 4. In FIG. 4, the sheet types included in the usage history are plain paper, thin paper, and thick paper. For example, in FIG. 5, when the print mode is the color mode and the present environment is NN, the fixing temperature corresponding to thin paper is 125° C., the fixing temperature corresponding to plain paper is 135° C., and the fixing temperature corresponding to thick paper is 150° C., and therefore the lowest temperature among these fixing temperatures (125° C.) is set as the first target temperature T1.

On determining that a cumulative print count Pz is lower than the defined value Tp (“No” in step S32), a lowest fixing temperature among fixing temperatures corresponding to all usable sheet types is set as the first target temperature T1 (step S37), and processing returns to the fixing roller temperature control. If Pz<Tp, it is considered that a trend of sheet type usage has not yet been established, and therefore determining the first target temperature T1 from the usage history is prohibited, and the first target temperature T1 is determined based on all usable sheet types.

For example, in FIG. 5, when the print mode is the color mode and the present environment is NN, the lowest fixing temperature among all sheet types including thin paper, recycled paper, and index paper is 125° C., and therefore 125° C. is set as the first target temperature T1. In this way the first target temperature T1 is set as one fixing temperature among a fixing temperature group of fixing temperatures suitable for different sheet types, and is therefore a temperature higher than the standby temperature T0.

Returning to FIG. 9, in step S16, the heater 143 is controlled to start increasing the temperature of the fixing roller 141 from the standby temperature T0 towards the first target temperature T1. This start of temperature increase is also known as a start of a first temperature control.

In a period from the start of the first temperature control until a start of a temperature control of the second target temperature T2 of the fixing roller 141 in step S21 (described later; also referred to as a start of a second temperature control), when the temperature of the fixing roller 141 reaches the first target temperature T1, the first target temperature T1 is maintained until the start of the second temperature control.

A time required from the start of sheet feeding in step S12 to completion of the first target temperature processing in step S15 depends on processing capacity of the heater controller 68, but is very short, for example several milliseconds, and therefore the start of sheet feeding and the start of temperature increase of the fixing roller 141 towards the first target temperature T1 can be regarded as simultaneous. After the start of temperature increase, the type of the sheet S is detected when the sheet S passes the detection position of the media sensor 36 (step S3 in FIG. 8).

When it is determined that the type of the sheet S has been detected (“Yes” in step S17), the detected sheet type is stored in the sheet type detection result storage 71 as sheet type information 710 (step S18).

Then the target temperature corresponding to the detected sheet type is set as the second target temperature T2 (step S19). Determination of the second target temperature T2 is performed referring to the target temperature determination table 69. More specifically, when the detected sheet type is plain paper, the print mode is the color mode, and the environment is NN, the temperature is set as 135° C. The same applies for other sheet types, print modes, and environments. That is, in the target temperature determination table 69, the temperature written in a column corresponding to the detected sheet type, print mode to be executed, and detected device temperature and humidity (environment) is set.

When the second target temperature T2 is set, the target temperature of the fixing roller 141 is switched from the first target temperature T1 to the second target temperature T2 (step S20), and the temperature control of the second target temperature T2 (second temperature control) is started (step S21). The second temperature control is performed by controlling the heater 143 so that the temperature of the fixing roller 141 is maintained at the second target temperature T2.

If the first target temperature T1 and the second target temperature T2 are the same, the temperature of the fixing roller 141 is controlled to be maintained at the second target temperature T2, which is the same as the first target temperature T1 set since the start of temperature increase. If the second target temperature T2 is higher than the first target temperature T1, after the temperature of the fixing roller 141 reaches the target temperature T2 via the first target temperature T1, the temperature is maintained at the second target temperature T2.

When the printing operation is completed after the temperature control of the second target temperature T2, the print mode is changed to the standby mode (step S22) and the control is ended. Changing to the standby mode is performed by switching the target temperature from the second target temperature T2 to the standby temperature.

For a sheet S fed in this way, the temperature increase of the fixing roller 141 from the standby temperature to the first target temperature T1 is started before the sheet type is detected by the media sensor 36, and when the sheet type is detected by the media sensor 36, the temperature is adjusted to a fixing temperature suitable for the detected sheet type (the second target temperature T2).

As a result, by the time the sheet type is detected by the media sensor 36, the temperature of the fixing roller 141 has already increased to some extent from the standby temperature towards the first target temperature T1. Accordingly, the time required for the fixing roller 141 to increase to the fixing temperature is shorter than a configuration in which temperature increase from the standby temperature to the fixing temperature waits for the media sensor 36 to complete detection of the sheet type, and the FPOT is shortened accordingly.

The first target temperature T1 is not based on the detection result of the actual sheet type of the media sensor 36, but the usage history of the sheets S in steps S31 to S35 of the first target temperature determination processing. Thus, for example, if one type of sheet, plain paper, had been used almost exclusively until the present time, the sheet type stored in the sheet cassette 31 is quite likely to be plain paper, and therefore before detection of the actual sheet type, a fixing temperature corresponding to plain paper that is assumed to be stored can be set as the first target temperature T1.

If the first target temperature T1 turns out to match the second target temperature T2 (fixing temperature) corresponding to the actually detected sheet type, the increase to the first target temperature T1 is substantially equivalent to an increase to the fixing temperature. When the first target temperature T1 is determined to be somewhat lower than the fixing temperature, then when the target temperature is switched to the fixing temperature after being increased to the first target temperature T1, it becomes necessary to increase the temperature again, meaning increasing in two stages, taking more time to increase the temperature of the fixing roller 141 from the standby temperature to the fixing temperature.

In contrast, if the first target temperature T1 matches the fixing temperature, there is no need to increase the temperature in two stages, and the time required to increase the temperature of the fixing roller 141 from the standby temperature to the fixing temperature can be further shortened.

Further, in steps S36 and S37 of the first target temperature determination processing, if the usage count of sheets S is still low or there is no significant difference in usage frequency of different sheet types, a method is used in which the first target temperature T1 is set to the lowest temperature among different fixing temperatures in a fixing temperature group, instead of a method in which the first target temperature T1 is set according to a usage history.

According to this method, the first target temperature T1 never exceeds the second target temperature T2, and therefore the temperature is not decreased to the second target temperature T2 after being increased to the first target temperature T1, preventing heat loss caused by cooling. However, if the degree of heat loss or cooling has hardly any effect on the FPOT, the first target temperature T1 may be greater than the second target temperature T2.

On the other hand, if it is determined in step S13 that it is not the first sheet feeding operation after an opening/closing operation of the sheet cassette 31, i.e., a second or subsequent sheet S is being fed (“No” in step S13), a target temperature corresponding to a sheet type currently stored in the sheet type detection result storage 71, detected when the first sheet S was fed, is set as the second target temperature (step S23), and processing proceeds to step S20. Determining the second target temperature is performed by the same method described in step S19. Further, if sheet type automatic detection is not selected (“No” in step S14), processing proceeds to step S23.

In this way, in the cases of a second or subsequent sheet feeding operation after an opening/closing operation of the sheet cassette 31 or sheet type automatic detection not being selected, the processing of steps S15 to S19, i.e., processing determining the second target temperature, does not occur, and this is for the following reason.

It is assumed that the opening/closing operation of the sheet cassette 31 by a user most likely indicates replenishing the sheet cassette 31 with a new ream of sheets S after the sheets S in the sheet cassette 31 run out. A user replenishing the sheets S in the sheet cassette 31 is often an operation of setting an unsealed ream of a defined number of sheets S in the sheet cassette 31, as described above. In such a case, all the of the sheets S added to the sheet cassette 31 are of the same type. In the case of the same type of sheets S, it is not necessary to identify the type of each of the sheets S from the second onwards as long as the sheet S first fed out is identified. In other words, it suffices to use the type of the first sheet S for the second and subsequent sheets S.

(5) Comparing Fixing Roller 141 Temperature Control of an Embodiment and a Reference Example

FIG. 11A illustrates a timing chart of temperature control of an embodiment using the first target temperature and FIG. 11B illustrates a timing chart of temperature control of a reference example not using the first target temperature. FIG. 11A and FIG. 11B each illustrate sheet feed control for a sheet S that is first to be fed after an opening/closing operation of the sheet cassette 31. Further, FIG. 11A and FIG. 11B illustrate a case in which print start instruction is received while in the standby mode, and where the standby mode is switched to the print mode by reception of the print start instruction.

As the embodiment illustrates in FIG. 11A, when a print start instruction is received (time ta), feeding of the first sheet S from the sheet cassette 31 is started and increasing temperature of the fixing roller 141 towards the first target temperature T1 is started (fixing preparation). This preparation is the start of the first temperature control, and corresponds to the processing of step S16 illustrated in FIG. 9.

In parallel with the first temperature control, the first sheet S is fed from the sheet cassette 31 by the feeding roller 32 and conveyed to the stopped resist roller pair 34 via the conveyance roller pair 33. Then, when a defined amount of arching occurs at the leading end of the sheet S, the feeding roller 32 and the conveyance roller pair 33 stop, temporarily stopping conveyance of the sheet S (feed operation completed: time tc). When the sheet S passes the detection position of the media sensor 36, the sheet type is detected (time tb), and when the second target temperature T2 corresponding to the sheet type is determined (step S19 in FIG. 9), the second temperature control is started to control the temperature of the fixing roller 141 to become the second target temperature T2 (step S21 in FIG. 9).

After the start of the second temperature control, the start of image formation is instructed by an image formation start signal (detection of a change in signal from a high level to a low level at time td), and when the defined time a has elapsed, conveyance of the sheet S is resumed by rotation of the resist roller pair 34 (time te).

When the temperature of the fixing roller 141 reaches the second target temperature T2 (fixing temperature, time tf), the fixing roller 141 is maintained at the fixing temperature. The time required for fixing preparation (time ta to time tf) is also referred to as warmup time. Then, the leading end in the conveyance direction of the sheet S for which conveyance has been resumed reaches the fixing nip 145 via the secondary transfer position 37 (time tg), and fixing is executed as the sheet S passes through the fixing nip 145.

On the other hand, according to the reference example, the feeding of the sheet S is started by the print start instruction (time ta), but the standby mode is continued until the sheet type detection is completed (time tb). The embodiment and the reference example use matching reference signs such that the time ta for the embodiment is the same as the time ta for the reference example, and the same applies for the time tb and the time tc.

When the sheet type is detected (time tb) and the fixing temperature corresponding to the sheet type is determined, the standby mode ends and the increase of the temperature of the fixing roller 141 from the standby temperature to the fixing temperature is started (fixing preparation).

After the start of fixing preparation, when the defined time a has elapsed after the start of image formation is instructed by the image formation start signal (time ti), the conveyance of the sheet S is resumed by the rotation of the resist roller pair 34 (time tj). The operation of resuming sheet conveyance after the start of image formation is the same in the embodiment and the reference example.

When the temperature of the fixing roller 141 reaches the fixing temperature (time tm), the fixing roller 141 is maintained at the fixing temperature, the leading end in the conveyance direction of the sheet S for which conveyance has been resumed reaches the fixing nip 145 via the secondary transfer position 37 (time tn), and fixing is executed as the sheet S passes through the fixing nip 145.

In the reference example, the standby temperature is maintained until detection of the sheet type is completed (time tb), and after detection of the sheet type is completed, the temperature starts increasing towards the fixing temperature determined by the sheet type (fixing preparation), and therefore the timing of the start of image formation (time ti) is delayed by a time tz when compared to the timing of the start of image formation (time td) of the embodiment.

On the other hand, according to the embodiment, prior to the detection of sheet type, specifically in synchronization with the start of feeding of the sheet S, the temperature starts to increase from the standby temperature to the first target temperature T1, and when the sheet type is detected, the temperature is controlled to reach the fixing temperature suitable for the detected sheet type (second target temperature T2).

Accordingly, at the time tb when the sheet type is detected, the temperature of the fixing roller 141 has already increased to some extent from the standby temperature towards the first target temperature T1. As a result, according to the embodiment, in contrast to the reference example that waits for sheet type detection completion to start increasing temperature from the standby temperature to the fixing temperature, the time required to increase temperature of the fixing roller 141 to the fixing temperature from the print start instruction can be shortened, and the image forming operation can be started earlier by the time tz. Starting the image formation earlier is equivalent to starting to resume sheet conveyance earlier, and the FPOT can therefore be shorter than that of the reference example.

If the sheet type is registered in advance by a user in the sheet type manual input mode (“No” in step S14 in FIG. 9), the increase towards the appropriate fixing temperature for the sheet type can start immediately from the print start instruction (time ta).

On the other hand, even in the sheet type automatic input mode, according to the embodiment, if the first target temperature T1 in the first temperature control is equivalent to the second target temperature T2 that is the fixing temperature, the temperature increase towards the fixing temperature can be started from the print start instruction. In practice, as in the case in which sheet type is registered in advance, the time required to raise the temperature towards the fixing temperature from the print start instruction can be minimized.

The present disclosure is not limited to image forming devices, and may be a temperature control method of a fixing unit. Further, the method may be a program executable by a computer. Further, the program may be recorded on a computer-readable storage medium such as a magnetic disk such as a magnetic tape or flexible disk, an optical storage medium such as a digital versatile disc read-only memory (DVD-ROM), digital versatile disc random-access memory (DVD-RAM), compact disc read-only memory (CD-ROM), compact disc recordable (CD-R), magnetic optical (MO), Phase-change Dual (PD), or the like, a flash memory storage medium, or the like. Such a program may be produced, transferred, etc., in the form of the storage medium, or may be transmitted and supplied via a wired or wireless network such as the Internet, broadcasting, telecommunication lines, satellite communication, or the like.

(6) Modifications

A description has been provided based on an embodiment, but of course the present disclosure is not limited to the embodiment described above, and includes the following modifications.

(6-1) According to an embodiment described above, the first target temperature T1 is determined in the first target temperature determination processing, but methods of determining the first target temperature T1 are not limited to this example. For example, a configuration may be adopted in which, among different fixing temperatures corresponding to different usable sheet types, a temperature less than or equal to than the lowest fixing temperature and higher than the standby temperature is stored in advance in the storage as the first target temperature T1.

As a specific example, in the target temperature determination table 69 illustrated in FIG. 5, the lowest temperature among the different fixing temperatures is 115° C., and the standby temperature is 100° C., and therefore a temperature satisfying the condition of being greater than 100° C. and equal to or less than 115° C. may be stored as the first target temperature T1. According to this configuration, only a process of reading the stored first target temperature T1 is performed in the first target temperature determination processing (step S15) illustrated in FIG. 9. In a configuration in which the standby temperature in the standby mode is switched to a different standby temperature depending on environmental conditions, the first target temperature T1 may be set to satisfy the conditions of being greater than the highest standby temperature and equal to or less than the lowest fixing temperature.

(6-2) According to an embodiment described above, an example is described of the first temperature control starting to increase temperature of the fixing roller 141 (fixing member) towards the first target temperature T1 from the start of feeding accompanying the print start instruction, but the timing of the start of the first temperature control (the start of fixing preparation) is not limited to this example.

For example, in the case of a device configuration in which the reception of a print start instruction and the start of feeding are not synchronized and the start of feeding is a certain time (such as 1 second) after reception of the print start instruction, it is also possible to control the first temperature control to start upon reception of the print start instruction. More specifically, situations in which fixing preparation are started at the same time as reception of a print start instruction and situations in which fixing preparation starts after a defined time has elapsed after reception of a print start instruction are included in the scope of the present disclosure. Similarly, sheet feeding can be started simultaneously with fixing preparation, or can be started when a defined time has elapsed since the start of fixing.

(6-3) According to an embodiment described above, in the first temperature determination processing, a relationship between usage frequency and the defined value Tq (steps S33, S34) is used to switch between using the fixing temperature corresponding to the sheet type with the highest usage frequency to determine the first target temperature T1 (step S35) and using the lowest fixing temperature among fixing temperatures corresponding to sheet types included in the usage history (step S36), but the first temperature determination processing is not limited to this example.

For example, regardless of the relationship between usage frequency and the defined value Tq, the fixing temperature corresponding to the most frequently used sheet type may be set as the first target temperature T1, or the lowest fixing temperature among fixing temperatures corresponding to sheet types included in the usage history may be set as the first target temperature T1.

Further, regardless of the relationship between the cumulative print count Pz and the defined value Tp (without executing steps S31 and S32), the lowest fixing temperature corresponding to all usable sheet types may be set as the first target temperature T1 (step S37).

(6-4) According to an embodiment described above, after passing the conveyance roller pair 33, the sheet type of the sheet S approaching the resist roller pair 34 is detected when the sheet S passes the detection position of the media sensor 36, but the sheet type detection position is not limited to this example. The sheet type detection position may be any position that allows completion of temperature increase of the fixing roller 141 to the fixing temperature determined according to the detection of sheet type by the time the sheet S reaches the fixing roller 141. For example, the sheet type detection position can be set to a position downstream of the feeding roller 32 in the conveyance direction and upstream of the conveyance roller pair 33 in the conveyance direction. Further, a structure may be adopted in which the type of sheet S is detected while stored in the sheet cassette 31 instead of after sheet feeding is started, i.e., before sheet feeding is started. In such a case, the media sensor 36 can be disposed in the sheet cassette 31.

(6-5) According to an embodiment described above, an example control is described in which the first temperature control and the second temperature control are performed sequentially only for the first sheet S fed after an opening/closing operation of the sheet cassette 31, but the present disclosure is not limited to this example. For example, instead of the sheet cassette 31 in which a large number of sheets S are set in advance, when a print job is executed for one or a small number of sheets S fed from a sheet storage such as a manual feed tray set by a user, the control can be applied not only to the first sheet but also to the second and subsequent sheets. The control may also be applied to the second and subsequent sheets S fed from the sheet cassette 31.

(6-6) According to an embodiment described above, power saving is performed by changing to a standby mode in which an amount of electrical power supplied to the heater 143 during non-image formation is lower than during printing, but the present disclosure is not limited to this example. For example, a structure may be adopted in which the power supply to the heater 143 is cut off and temperature control of the fixing roller 141 is not executed (also referred to as a heater off mode) from completion of a print job until reception of the next print job execution instruction (during non-image formation).

In the case of this structure, in the example illustrated in FIG. 11A, during the non-image formation prior to the print start instruction (time ta), the heater off mode is executed instead of the standby mode, and the heater off mode is changed to the print mode on reception of the print start instruction.

(6-7) According to an embodiment described above, a control is described in which a start timing of resumption of conveyance of the sheet S towards the secondary transfer position 37 is matched to a timing of the toner image on the intermediate transfer belt 21 arriving at the secondary transfer position 37, after the sheet S is temporarily stopped on the conveyance path 38 by using the resist roller pair 34, but the sheet S need not be temporarily stopped in this way.

For example, a control may be adopted in which rotation speed of the resist roller pair 34 is adjusted so that the timing of the toner image on the intermediate transfer belt 21 reaching the secondary transfer position 37 matches the timing of the leading end of the sheet S reaching the secondary transfer position 37. More specifically, until the leading end of the sheet S reaches the secondary transfer position 37, the conveyance speed of the sheet S is reduced below the normal print conveyance speed (system speed). According to this control, when the leading end of the sheet S reaches the secondary transfer position 37, the rotation speed of the resist roller pair 34 is returned to the normal print conveyance speed.

(6-8) According to an embodiment described above, the sheet S is conveyed at a constant system speed, but the present disclosure is not limited to this example. For example, conveyance speed from the resist roller pair 34 to the discharge roller pair 39 may be variably controlled according to the sheet type detected by the media sensor 36. For example, thick paper usually requires more heat for heat fixing that plain paper, and therefore conveyance speed of thick paper can be made slower than that of plain paper by a certain amount required to apply the necessary amount of heat to the thick paper.

According to this control, the sheet S is transported at the normal system speed (first speed) from the sheet cassette 31 to the resist roller pair 34, and at a variable speed (second speed) depending on sheet type from the resist roller pair 34 to the discharge roller pair 39. The rotation speeds of the resist roller pair 34, the fixing roller 141, the discharge roller pair 39, and the like, and the circumferential speed of the intermediate transfer belt 21, can be switched between the system speed and a speed corresponding to sheet type.

(6-9) According to an embodiment described above, the image forming device is a tandem-type color printer, but the present disclosure is not limited to this example. Instead of color image forming, the image forming device may only execute monochrome image forming.

An image forming device may be a structure that forms an image such as a toner image on an image bearing member such as a photosensitive member or intermediate transfer member, transfers the formed image onto a sheet being conveyed at a transfer position, and heat fixes the image to the sheet in a fixing unit, detecting sheet type by a means such as a sensor prior to conveying the sheet to the fixing unit, and adjusting the temperature at a fixing member according to a result of the detection of sheet type. This structure can be applied to a copy machine, a facsimile machine, a multi-function peripheral (MFP), a typical image forming device, or the like. Further, target temperatures, sheet types, threshold values and the like are not limited to the examples provided, and appropriate values can be determined according to device structure.

Further, contents of any described embodiment and modification may be combined in any possible combination.

### <Review>

The content of the above described embodiments and modifications illustrate one aspect for solving the technical problem described under the heading “SUMMARY”, and may be summarized as follows:

An image forming device pertaining to at least one embodiment of the present disclosure is an image forming device that, when an image forming start instruction is received, feeds a sheet from a sheet storage, forms an image on the sheet, conveys the sheet to a fixing member heated by a heater, and thermally fixes the image on the sheet by using the fixing member, the image forming device including: a sheet type detector that detects a type of the sheet before the sheet reaches the fixing member; a temperature detector that detects a temperature of the fixing member; and a central processing unit (CPU). The CPU controls the heater based on a result of detection by the temperature detector to (a) after the reception of the image formation start instruction and before a start of detection of the type of the sheet by the sheet type detector, start an increase in temperature of the fixing member towards a first target temperature that is higher than the temperature of the fixing member when the image formation start instruction is received, and (b) after completion of the detection of the type of the sheet and before the sheet reaches the fixing member, adjust the temperature of the fixing member to a second target temperature that depends on the type of the sheet detected.

According to at least one embodiment, the CPU controls the heater to start the increase in the temperature of the fixing member towards the first target temperature from a start of the feeding of the sheet from the sheet storage.

According to at least one embodiment, the CPU acquires a sheet type having a greatest usage frequency from history information indicating past sheet type usage, and sets the first target temperature to be equal to a target temperature determined according to the sheet type acquired.

According to at least one embodiment, the CPU, when the greatest usage frequency is smaller than a first defined value Tq, sets the first target temperature to a lowest temperature among target temperatures corresponding to different types of sheet included in the history information, instead of the target temperature determined according to the sheet type acquired.

According to at least one embodiment, the CPU, when a cumulative image formation count Pz that is a count of all sheets that have undergone image forming in the image forming device is smaller than a second defined value Tp, sets the first target temperature to a lowest temperature among target temperatures corresponding to all types of sheet usable by the image forming device, instead of using the history information to set the first target temperature.

According to at least one embodiment, the CPU sets the first target temperature to be equal to a lowest target temperature among target temperatures corresponding to different sheet types included in history information indicating past sheet type usage.

According to at least one embodiment, the CPU sets the first target temperature to be equal to a lowest target temperature among target temperatures corresponding to different types of sheet usable by the image forming device.

According to at least one embodiment, the first target temperature is lower than every target temperature for a different type of sheet usable by the image forming device.

According to at least one embodiment, the image forming device further includes: an image forming unit capable of switching between a monochrome mode of forming a monochrome image on the sheet using a single color of toner and a color mode of forming a color image on the sheet using multiple different colors of toner; and an environment detector that detects an ambient environment around the fixing member, wherein the CPU determines the second target temperature taking into consideration a mode to be executed out of the monochrome mode and the color mode and the ambient environment detected by the environment detector in addition to the type of the sheet detected.

According to at least one embodiment, the image forming device further includes: a sheet feeder that feeds the sheet from the sheet storage to a resist roller at a first speed; and a conveyance unit that conveys the sheet from the resist roller to a transfer position where the image is transferred to the sheet, and to a discharge roller via the fixing member to be discharged outside the image forming device, wherein the sheet type detector detects the type of the sheet before the sheet reaches the resist roller, and the conveyance unit conveys the sheet at a second speed dependent on the type of the sheet detected.

According to the above-described embodiments, the temperature increase of the fixing member towards the first target temperature is started before the sheet type detector has completed detection of the sheet type, and therefore the temperature of the fixing member is already increased by the time the sheet type detector has completed detection of the sheet type.

Accordingly, the timing at which the fixing member reaches the second target temperature suitable for the sheet type can be earlier than in a structure in which temperature increase of the fixing member starts after the sheet type detector completes sheet type detection, and therefore it is possible to shorten the first print output time by bringing forward the timing at which the first sheet is conveyed to the fixing member.

Although one or more embodiments of the present invention have been described and illustrated in detail, the disclosed embodiments are made for the purposes of illustration and example only and not limitation. The scope of the present invention should be interpreted by the terms of the appended claims.

What is claimed is:

1. An image forming device that, when an image forming start instruction is received, feeds a sheet from a sheet storage, forms an image on the sheet, conveys the sheet to a fixing member heated by a heater, and thermally fixes the image on the sheet by using the fixing member, the image forming device comprising:
a sheet type detector that detects a type of the sheet before the sheet reaches the fixing member;
a temperature detector that detects a temperature of the fixing member; and
a central processing unit (CPU) that controls the heater based on a result of detection by the temperature detector to (a) after the reception of the image formation start instruction and before a start of detection of the type of the sheet by the sheet type detector, start an increase in temperature of the fixing member towards a first target temperature that is higher than the temperature of the fixing member when the image formation start instruction is received, and (b) after completion of the detection of the type of the sheet and before the sheet reaches the fixing member, adjust the temperature of the fixing member to a second target temperature that depends on the type of the sheet detected.

2. The image forming device of claim 1, wherein
the CPU controls the heater to start the increase in the temperature of the fixing member towards the first target temperature from a start of the feeding of the sheet from the sheet storage.

3. The image forming device of claim 1, wherein
the CPU acquires a sheet type having a greatest usage frequency from history information indicating past sheet type usage, and sets the first target temperature to be equal to a target temperature determined according to the sheet type acquired.

4. The image forming device of claim 3, wherein
the CPU, when the greatest usage frequency is smaller than a first defined value Tq, sets the first target temperature to a lowest temperature among target temperatures corresponding to different types of sheet included in the history information, instead of the target temperature determined according to the sheet type acquired.

5. The image forming device of claim 3, wherein
the CPU, when a cumulative image formation count Pz that is a count of all sheets that have undergone image forming in the image forming device is smaller than a second defined value Tp, sets the first target temperature to a lowest temperature among target temperatures corresponding to all types of sheet usable by the image forming device, instead of using the history information to set the first target temperature.

6. The image forming device of claim 1, wherein
the CPU sets the first target temperature to be equal to a lowest target temperature among target temperatures corresponding to different sheet types included in history information indicating past sheet type usage.

7. The image forming device of claim 1, wherein
the CPU sets the first target temperature to be equal to a lowest target temperature among target temperatures corresponding to different types of sheet usable by the image forming device.

8. The image forming device of claim 1, wherein
the first target temperature is lower than every target temperature for a different type of sheet usable by the image forming device.

9. The image forming device of claim 1, further comprising:
an image forming unit capable of switching between a monochrome mode of forming a monochrome image on the sheet using a single color of toner and a color mode of forming a color image on the sheet using multiple different colors of toner; and
an environment detector that detects an ambient environment around the fixing member, wherein
the CPU determines the second target temperature taking into consideration a mode to be executed out of the monochrome mode and the color mode and the ambient environment detected by the environment detector in addition to the type of the sheet detected.

10. The image forming device of claim 1, further comprising:
a sheet feeder that feeds the sheet from the sheet storage to a resist roller at a first speed; and
a conveyance unit that conveys the sheet from the resist roller to a transfer position where the image is transferred to the sheet, and to a discharge roller via the fixing member to be discharged outside the image forming device, wherein
the sheet type detector detects the type of the sheet before the sheet reaches the resist roller, and
the conveyance unit conveys the sheet at a second speed dependent on the type of the sheet detected.
